(19) United States
(12) Patent Application Publication
(10) Pub. No.: US 2024/0243523 A1
(43) Pub. Date: Jul. 18, 2024

(54) IMPEDANCE ADJUSTMENT METHOD AND CONNECTOR FOR HIGH-SPEED TRANSMISSION

(71) Applicant: Japan Aviation Electronics Industry, Ltd., Tokyo (JP)

(72) Inventor: Junji OOSAKA, Tokyo (JP)

(21) Appl. No.: 18/574,417

(22) PCT Filed: Jun. 29, 2022
(86) PCT No.: PCT/JP2022/026010

§ 371 Date: Dec. 27, 2023

(30) Foreign Application Priority Data
Oct. 8, 2021 (JP) 2021-165969

(51) Int. Cl. H01R 13/6474; H01R 12/52; H01R 13/621; H01R 43/00

(52) U.S. Cl. CPC H01R 13/6474; H01R 12/52; H01R 43/00; H01R 13/6215

(57) ABSTRACT

Each contact is designed in such a way that one contact part is supported by two spring pieces extending apart from each other and parallel to each other in a pitch direction and whose both ends are joined. No conductor is designed to exist between the two spring pieces of each contact. No conductor is designed to exist between the two contacts adjacent in the pitch direction. An outer spring gap is narrowed by separating the two spring pieces of each contact away from each other in the pitch direction while maintaining the predetermined pitch and the cross-sectional areas and cross-sectional shapes of the two spring pieces of each contact, thereby reducing the impedance of each contact while maintaining the predetermined pitch and the elasticity of each contact.

### TECHNICAL FIELD

The present invention relates to an impedance adjustment method and a connector for high-speed transmission.

### BACKGROUND ART

As shown in FIG. 16 of the present application, Patent Literature 1 (Japanese Patent No. 6901603) discloses a board-to-board connector 101 in which a plurality of contacts 100 are arranged in a row.

### SUMMARY OF INVENTION

### Technical Problem

For higher speed transmission of the board-to-board connector 101 according to the above-described Patent Literature 1, it is required to reduce the impedance of each contact 100. A typical technique to reduce the impedance of each contact 100 is narrowing the pitch of a plurality of contacts 100. This narrows the gap between two contacts 100 adjacent in the pitch direction, which reduces the impedance of each contact 100. In this case, however, it is necessary to simultaneously enhance the positioning accuracy of a board to be connected with the board-to-board connector 101 on the board-to-board connector 101, which is not practical.

Another technique to reduce the impedance of each contact 100 is widening each contact 100 without changing the pitch of the plurality of contacts 100. This also narrows the gap between two contacts 100 adjacent in the pitch direction, which reduces the impedance of each contact 100. In this case, however, each contact 100 is hardened and thereby likely to be settled, thus causing another problem.

In short, it has been unable to reduce impedance without changing the pitch and elasticity of contacts.

An object of the present invention is to provide a technique of reducing impedance without changing the pitch and elasticity of contacts.

### Solution to Problem

According to a first aspect of the present invention, there is provided an impedance adjustment method for adjusting impedance of each contact in a connector where a plurality of contacts having electrical conductivity are arranged in a row with a predetermined pitch, wherein each contact is designed in such a way that one contact part is supported by two spring pieces extending apart from each other and parallel to each other in a pitch direction and whose both ends are joined, no conductor is designed to exist between the two spring pieces of each contact, no conductor is designed to exist between two contacts adjacent in the pitch direction, and a gap in the pitch direction between, of two contacts adjacent in the pitch direction, a spring piece closer to another contact out of the two spring pieces of one contact and a spring piece closer to the one contact out of the two spring pieces of the another contact is narrowed by separating the two spring pieces of each contact away from each other in the pitch direction while maintaining the predetermined pitch and cross-sectional areas and cross-sectional shapes of the two spring pieces of each contact, thereby reducing impedance of each contact while maintaining the predetermined pitch and elasticity of each contact.

According to a second aspect of the present invention, there is provided a connector for high-speed transmission where a plurality of contacts having electrical conductivity are arranged in a row with a predetermined pitch, wherein in each contact, one contact part is supported by two spring pieces extending apart from each other and parallel to each other in a pitch direction and whose both ends are joined, no conductor exists between the two spring pieces of each contact, no conductor exists between two contacts adjacent in the pitch direction, and a gap in the pitch direction between the two spring pieces of each contact is greater than a gap in the pitch direction between, of two contacts adjacent in the pitch direction, a spring piece closer to another contact out of the two spring pieces of one contact and a spring piece closer to the one contact out of the two spring pieces of the another contact.

Cross-sectional areas and cross-sectional shapes of the two spring pieces may be equal to each other.

The two spring pieces may be a cantilever beam at least partly bent in a U-shape.

Each contact may be formed symmetrically with respect to a center line.

The connector for high-speed transmission may further include an insulating housing that holds the plurality of contacts, wherein the housing includes a plurality of contact accommodation parts that accommodate the plurality of contacts, respectively, and a plurality of partition walls that separate the plurality of contact accommodation parts, respectively, in the pitch direction, and a corresponding partition wall is disposed between, of two contacts adjacent in the pitch direction, a spring piece closer to another contact out of the two spring pieces of one contact and a spring piece closer to the one contact out of the two spring pieces of the another contact.

Each contact may include a soldering part at an end on an opposite side of the contact part.

### Advantageous Effects of Invention

According to the present invention, impedance is reduced without changing the pitch and elasticity of contacts.

### BRIEF DESCRIPTION OF DRAWINGS

FIG. 1 is an exploded perspective view of an information processing device;

FIG. 2 is a perspective view of a CPU board when viewed from another angle;

FIG. 3 is a perspective view of a connector;

FIG. 4 is an exploded perspective view of the connector;

FIG. 5 is a perspective view of a housing;

FIG. 6 is a partially cutout perspective view of the connector;

FIG. 7 is a partially cutout perspective view of the connector;

FIG. 8 is a partially cutout perspective view of the connector;

FIG. 9 is a cross-sectional view of the connector corresponding to FIG. 6;

FIG. 10 is a perspective view of a contact;

FIG. 11 is a perspective view of the contact when viewed from another angle;

FIG. 12 is a plan view of the contact;

FIG. 13 is a perspective view of a contact row;

FIG. 14 is a partially cutout perspective view of the contact row;

FIG. 15 is an illustrative view of an impedance adjustment method; and

FIG. 16 is a simplified drawing of FIG. 3 of Patent Literature 1.

### DESCRIPTION OF EMBODIMENTS

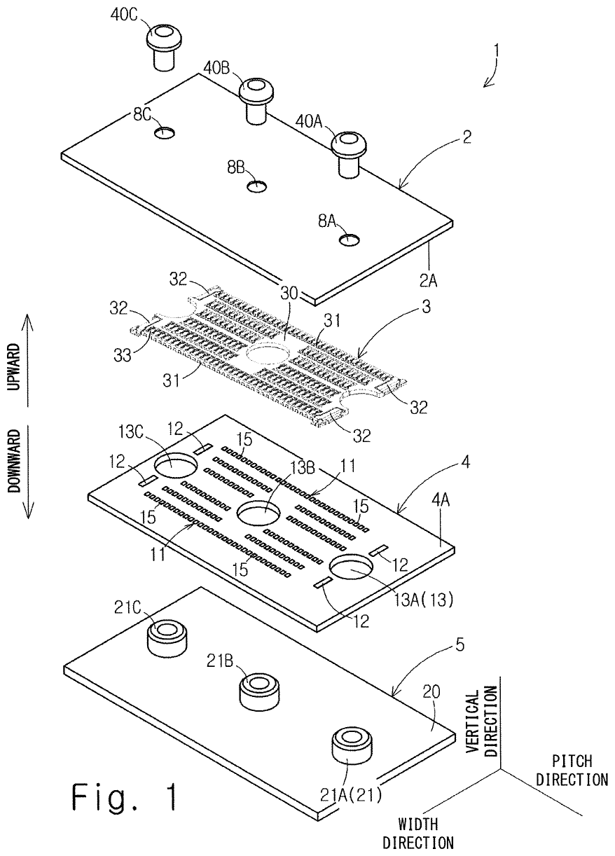

An embodiment of the present invention will be described hereinafter with reference to FIGS. 1 to 15. FIG. 1 is an exploded perspective view of an information processing device 1. As shown in FIG. 1, the information processing device 1 includes a CPU board 2 (first board), a connector 3 (connector for high-speed transmission), an input-output board 4 (second board), and a support board 5. The CPU board 2, the connector 3, the input-output board 4, and the support board 5 are placed on top of one another in this recited order. Specifically, the connector 3 is disposed between the CPU board 2 and the input-output board 4.

The CPU board 2 and the input-output board 4 are rigid boards such as a paper phenolic board or a glass epoxy board, for example.

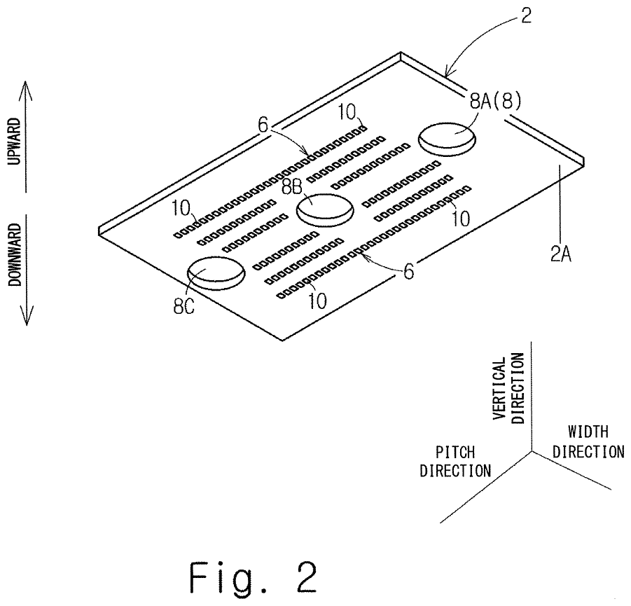

FIG. 2 is a perspective view of the CPU board 2 when viewed from another angle. As shown in FIGS. 1 and 2, the CPU board 2 includes a connector opposed surface 2A to be opposed to the connector 3. As shown in FIG. 2, a plurality of signal pad rows 6 are formed on the connector opposed surface 2A. Further, the CPU board 2 has a plurality of bolt fastening holes 8.

The plurality of signal pad rows 6 extend parallel to one another. Each of the signal pad rows 6 includes a plurality of signal pads 10. The longitudinal direction of each signal pad row 6 is referred to as a pitch direction. Further, the direction orthogonal to the pitch direction is defined as a width direction. The plurality of signal pad rows 6 are arranged in the width direction. The thickness direction of the CPU board 2 is orthogonal to the pitch direction and the width direction, and it is referred to hereinafter as a vertical direction. The vertical direction includes downward which the connector opposed surface 2A faces, and upward opposite to downward. Note that the vertical direction, the upward direction, and the downward direction are directions used by way of illustration only and should not be interpreted as limiting the position of the information processing device 1 and the connector 3 when they are actually used.

The plurality of bolt fastening holes 8 are disposed separately from each other in the pitch direction. The plurality of bolt fastening holes 8 include a first bolt fastening hole 8A, a second bolt fastening hole 8B, and a third bolt fastening hole 8C. The first bolt fastening hole 8A, the second bolt fastening hole 8B, and the third bolt fastening hole 8C are arranged in this recited order.

Referring back to FIG. 1, the input-output board 4 includes a connector opposed surface 4A to be opposed to the connector 3. A plurality of signal pad rows 11 and a plurality of hold-down pads 12 are formed on the connector opposed surface 4A. Further, the input-output board 4 has a plurality of bolt fastening holes 13.

The plurality of signal pad rows 11 extend parallel to one another. The plurality of signal pad rows 11 are arranged in the width direction. Each of the signal pad rows 11 includes a plurality of signal pads 15.

The plurality of bolt fastening holes 13 are disposed separately from each other in the pitch direction. The plurality of bolt fastening holes 13 include a first bolt fastening hole 13A, a second bolt fastening hole 13B, and a third bolt fastening hole 13C. The first bolt fastening hole 13A, the second bolt fastening hole 13B, and the third bolt fastening hole 13C are arranged in this recited order.

The support board 5 is typically a part of a casing that accommodates the CPU board 2, the connector 3, and the input-output board 4, and it is made of aluminum or aluminum alloy, for example. The support board 5 includes a flat-plate board main body 20, and a plurality of nuts 21. The plurality of nuts 21 project upward from the board main body 20.

The plurality of nuts 21 include a first nut 21A, a second nut 21B, and a third nut 21C. The first nut 21A, the second nut 21B, and the third nut 21C are disposed to correspond to the first bolt fastening hole 13A, the second bolt fastening hole 13B, and the third bolt fastening hole 13C of the input-output board 4, respectively.

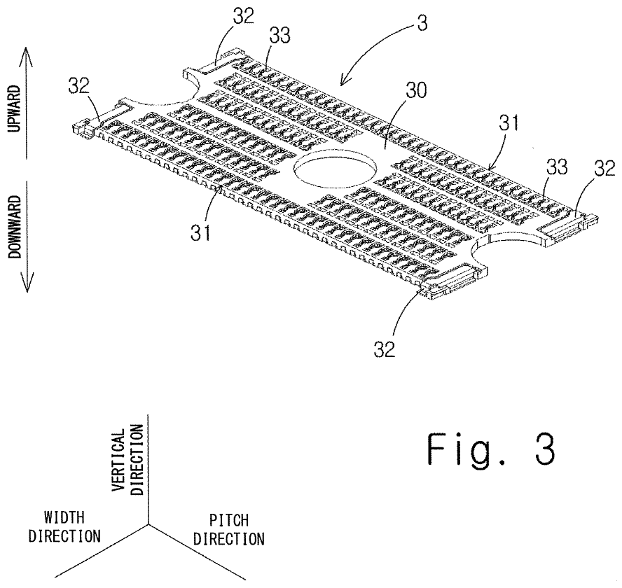

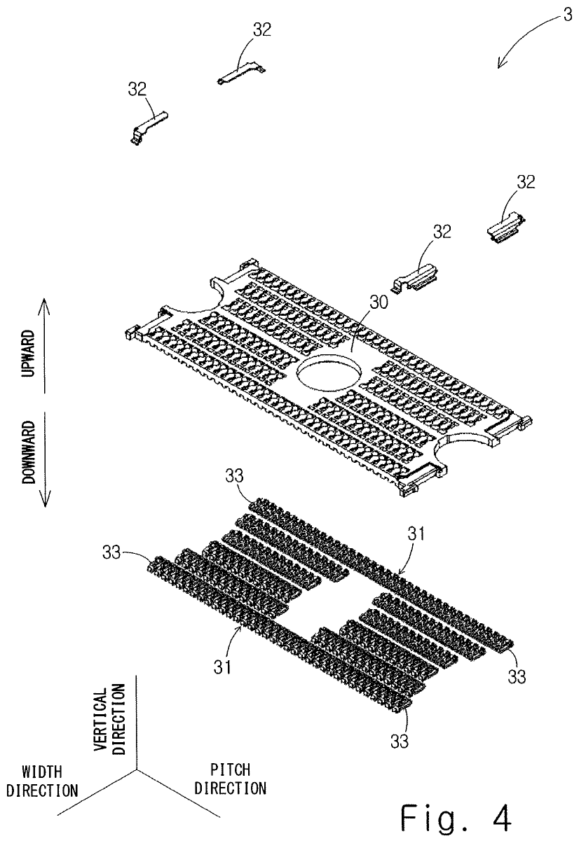

The connector 3 is mountable on the connector opposed surface 4A of the input-output board 4. FIG. 3 is a perspective view of the connector 3. FIG. 4 is an exploded perspective view of the connector 3. As shown in FIGS. 3 and 4, the connector 3 includes a rectangular flat-plate housing 30 made of insulating resin, a plurality of contact rows 31, and a plurality of hold-downs 32. The plurality of contact rows 31 and the plurality of hold-downs 32 are held on the housing 30.

The plurality of contact rows 31 extend parallel to one another. The plurality of contact rows 31 are arranged in the width direction. Each contact row 31 extends linearly in the pitch direction. Each contact row 31 includes a plurality of contacts 33. Each contact 33 is conductive and formed by punching and bending a metal plate formed by plating copper or copper alloy, for example.

As shown in FIG. 1, the plurality of hold-downs 32 are disposed to correspond to the plurality of hold-down pads 12 of the input-output board 4, respectively. Each hold-down 32 is formed by punching and bending a metal plate such as a stainless steel plate, for example.

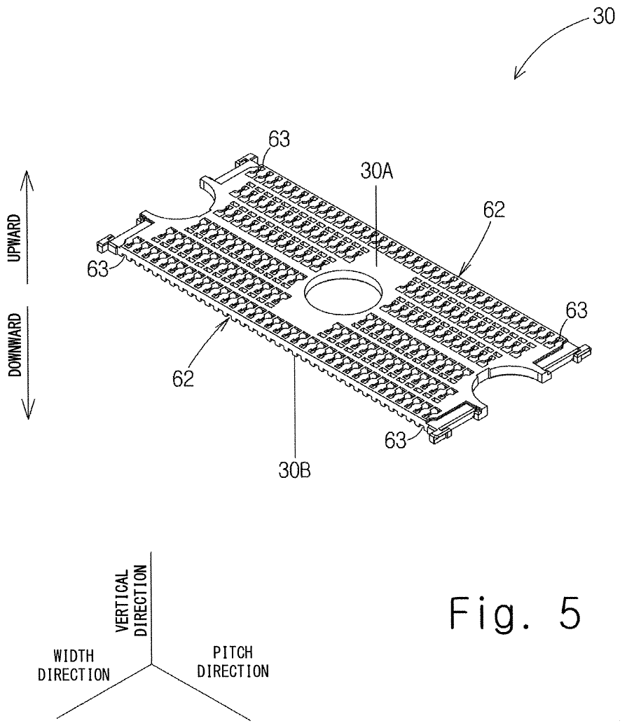

FIG. 5 is a perspective view of the housing 30. As shown in FIG. 5, the housing 30 includes a CPU board opposed surface 30A serving as a housing upper surface designed to be opposed to the CPU board 2 by facing upward, and an input-output board opposed surface 30B serving as a housing lower surface designed to be opposed to the input-output board 4 by facing downward. The CPU board opposed surface 30A is the uppermost surface of the housing 30. The input-output board opposed surface 30B is the lowermost surface of the housing 30.

Referring back to FIG. 1, the overview of the assembly procedure of the information processing device 1 is described.

First, the connector 3 is mounted on the input-output board 4. To be specific, the plurality of contact rows 31 are respectively soldered to the plurality of signal pad rows 11, and further the plurality of hold-downs 32 are respectively soldered to the plurality of hold-down pads 12.

Next, the input-output board 4 on which the connector 3 is mounted is placed on the support board 5. At this time, the first nut 21A, the second nut 21B, and the third nut 21C of the support board 5 penetrate the first bolt fastening hole 13A, the second bolt fastening hole 13B, and the third bolt fastening hole 13C of the input-output board 4, respectively.

Then, the CPU board 2 is attached to the support board 5 in such a way that the CPU board 2 overlaps the connector 3. To be specific, a first bolt 40A is fastened to the first nut 21A through the first bolt fastening hole 8A and the first bolt fastening hole 13A, a second bolt 40B is fastened to the second nut 21B through the second bolt fastening hole 8B and the second bolt fastening hole 13B, and a third bolt 40C is fastened to the third nut 21C through the third bolt fastening hole 8C and the third bolt fastening hole 13C. In this manner, the connector 3 is interposed between the CPU board 2 and the input-output board 4, and thereby the plurality of signal pads 15 of the input-output board 4 and the plurality of signal pads 10 of the CPU board 2 shown in FIG. 2 are respectively electrically connected through the plurality of contacts 33 of the connector 3.

The connector 3 according to this embodiment is designed for high-speed transmission, and the assumed frequency of a signal flowing through each contact 33 is from 10 GHz to 25 GHz. However, it is not limited thereto.

The connector 3 is described hereinafter in further detail.

As shown in FIG. 5, the housing 30 is formed in a rectangular flat-plate shape. A plurality of contact accommodation rows 62 are formed in the housing 30. The plurality of contact accommodation rows 62 extend parallel to one another. Each contact accommodation row 62 extends linearly in the pitch direction. The plurality of contact accommodation rows 62 are arranged in the width direction. Each contact accommodation row 62 includes a plurality of contact accommodation parts 63.

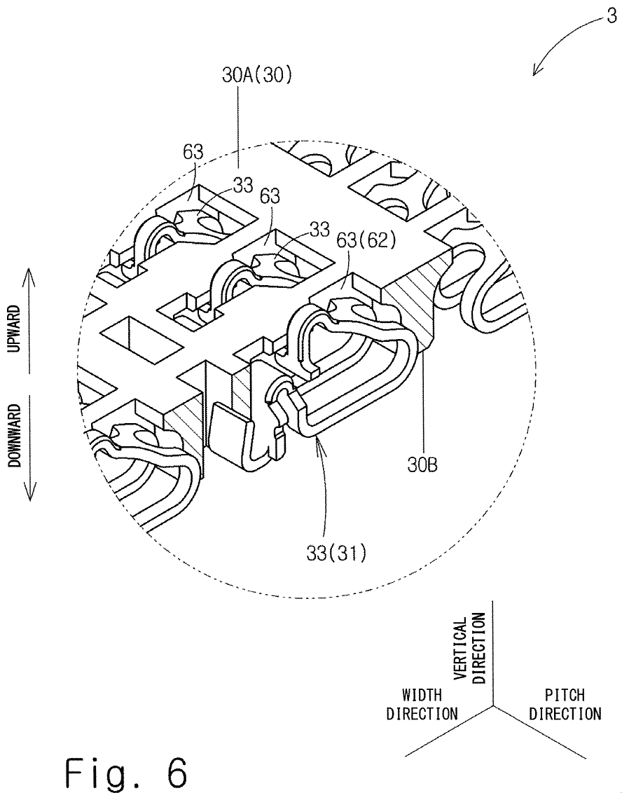

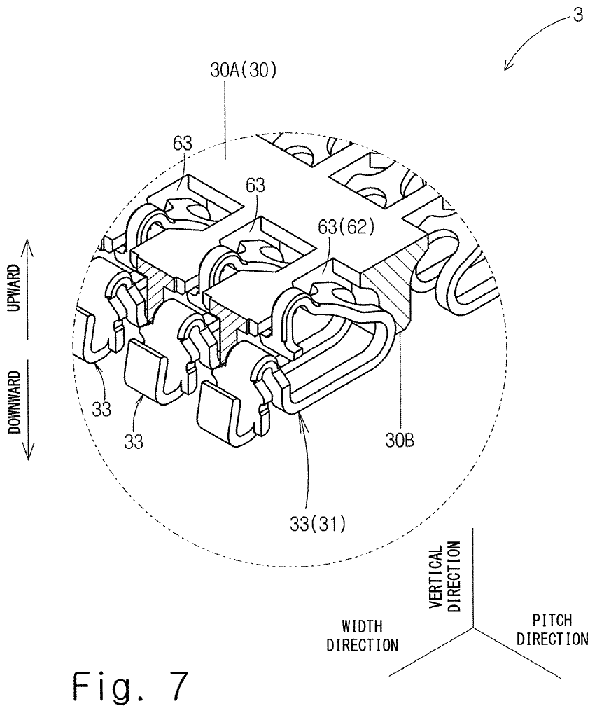

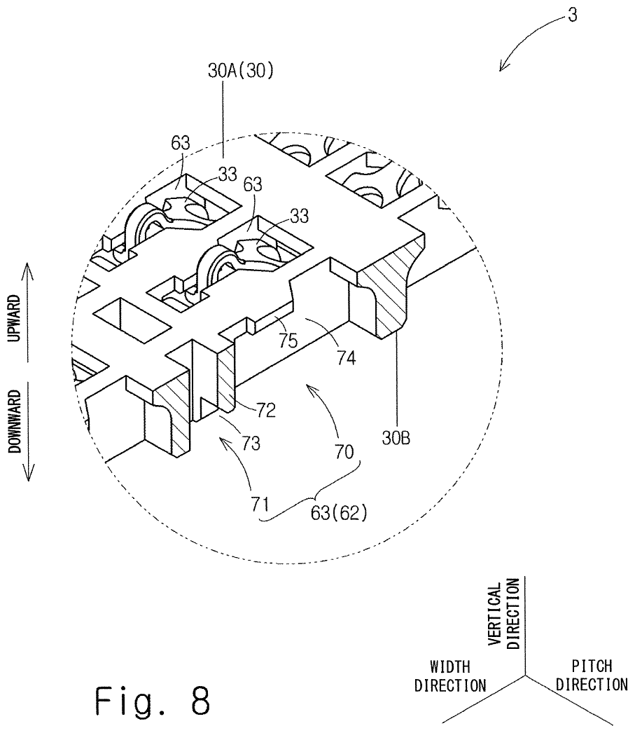

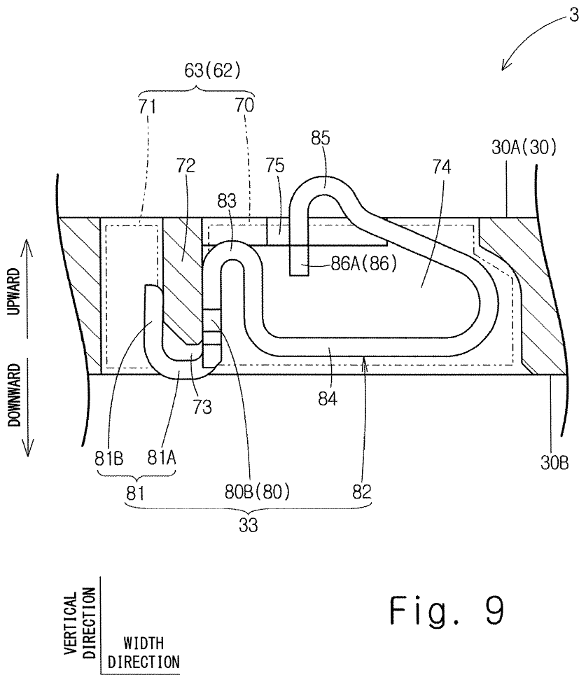

FIG. 6 is a partially cutout perspective view of the connector 3 where the housing 30 is cut along a plane orthogonal to the pitch direction. FIG. 7 is a partially cutout perspective view of the connector 3 where the housing 30 is cut along a plane orthogonal to the pitch direction and a plane orthogonal to the width direction. FIG. 8 is a partially cutout perspective view of the connector 3 where the housing 30 is cut along a plane orthogonal to the pitch direction. FIG. 9 is a cross-sectional view of the connector 3 where the housing 30 is cut along a plane orthogonal to the pitch direction.

As shown in FIGS. 6 and 7, the plurality of contact accommodation rows 62 accommodate the plurality of contact rows 31, respectively. In other words, the plurality of contact accommodation parts 63 accommodate the plurality of contacts 33, respectively. Each contact accommodation part 63 is formed to attach each contact 33 to the housing 30. As shown in FIG. 8, each contact accommodation part 63 is formed to penetrate the housing 30 in the vertical direction.

As shown in FIGS. 8 and 9, each contact accommodation part 63 includes a contact accommodation part main body 70 and a solder connection checking hole 71. The contact accommodation part main body 70 and the solder connection checking hole 71 are formed apart from each other in the width direction. Each of the contact accommodation part main body 70 and the solder connection checking hole 71 is formed to penetrate the housing 30 in the vertical direction.

The housing 30 includes a width separating wall 72 that separates, in the width direction, the contact accommodation part main body 70 and the solder connection checking hole 71 of the contact accommodation part 63. A notch 73 is formed at the lower end of the width separating wall 72.

The housing 30 includes a pitch separating wall 74 that separates, in the pitch direction, the contact accommodation part main bodies 70 of the two contact accommodation parts 63 adjacent to each other in the pitch direction. A restriction wall 75 that projects in the pitch direction is formed at the upper end of the pitch separating wall 74.

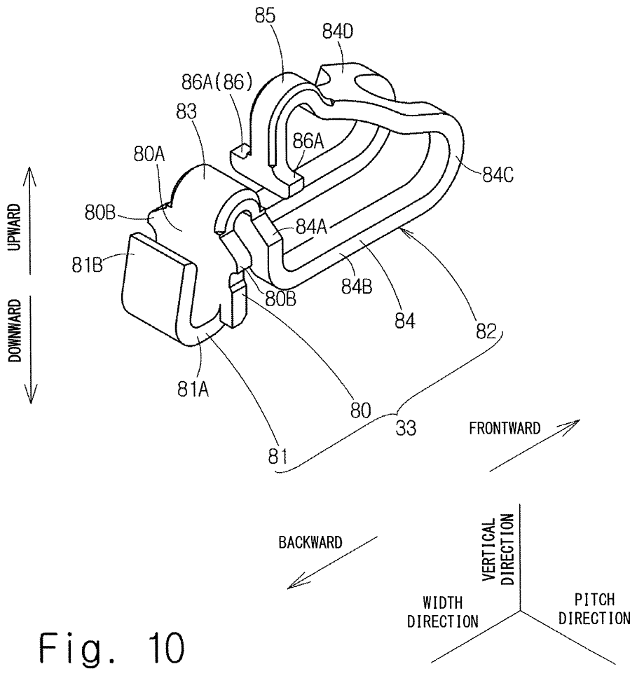

Each contact 33 is described hereinafter in detail with reference to FIGS. 10 to 12.

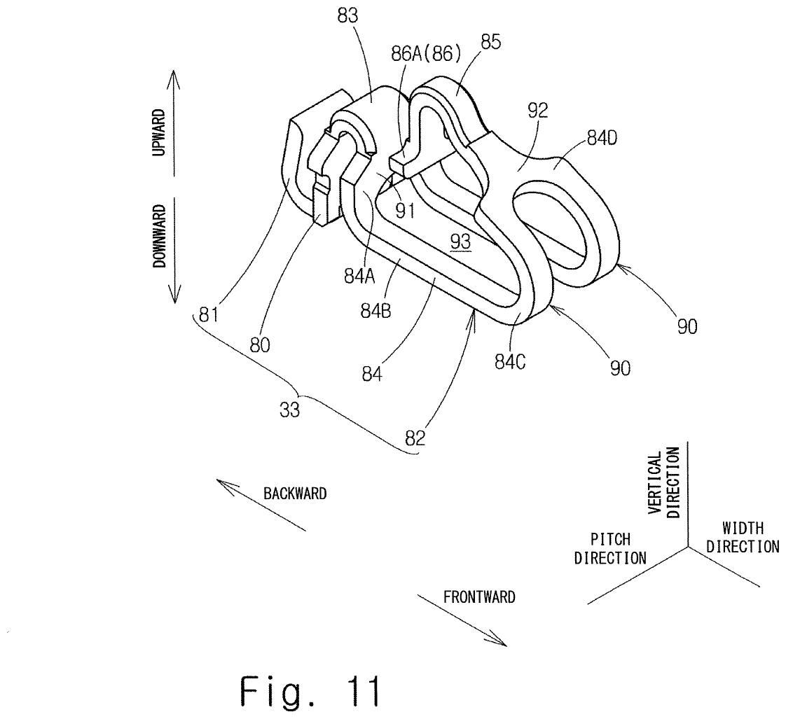

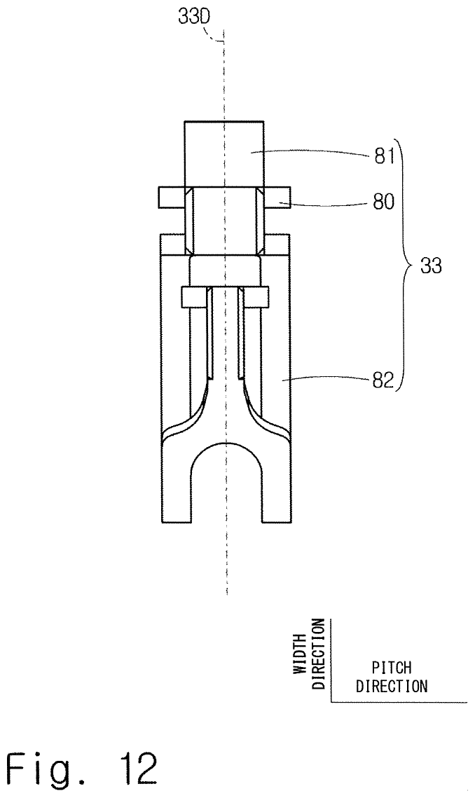

FIGS. 10 and 11 are perspective views of each contact 33. FIG. 12 is a plan view of each contact 33.

As shown in FIGS. 10 to 12, each contact 33 includes a fixed part 80, a soldering part 81, and an electrical contact spring piece 82.

The fixed part 80 is a part to be press-fit into the contact accommodation part main body 70 shown in FIG. 8. Specifically, the fixed part 80 is press-fit into the contact accommodation part main body 70, and thereby each contact 33 is held by the housing 30. The fixed part 80 is a plate body whose thickness direction is orthogonal to the pitch direction. The fixed part 80 includes a fixed part main body 80A and two press-fit lances 80B. The two press-fit lances 80B are formed to project in the pitch direction respectively from the both ends of the fixed part main body 80A in the pitch direction.

The soldering part 81 and the electrical contact spring piece 82 are disposed on the opposite sides to each other in the width direction with the fixed part 80 interposed therebetween. The direction of viewing the electrical contact spring piece 82 from the soldering part 81 is referred to as frontward, and the direction of viewing the soldering part 81 from the electrical contact spring piece 82 is referred to as backward. Thus, the electrical contact spring piece 82 is disposed on the frontward side of the fixed part 80, and the soldering part 81 is disposed on the backward side of the fixed part 80.

The soldering part 81 includes a soldering part main body 81A and a position stabilization spring piece 81B. The soldering part main body 81A is a part to be soldered to the corresponding signal pad 15 of the input-output board 4 shown in FIG. 1. As shown in FIG. 10, the soldering part main body 81A extends backward from the lower end of the fixed part 80. The position stabilization spring piece 81B projects upward from the backward end of the soldering part main body 81A.

The electrical contact spring piece 82 is a part that functions as an electrical contact point with the corresponding signal pad 10 of the CPU board 2 shown in FIG. 2. As shown in FIG. 10, the electrical contact spring piece 82 includes a curved joining part 83, an easily elastically deformable part 84, a contact part 85, and a displacement restriction part 86. The curved joining part 83, the easily elastically deformable part 84, the contact part 85, and the displacement restriction part 86 link together in this recited order.

The curved joining part 83 projects frontward from the upper end of the fixed part 80 and curves in a U-shape so as to be convex upward and open downward.

When the easily elastically deformable part 84 is observed along the line of sight in the pitch direction, the easily elastically deformable part 84 includes a vertical part 84A, a horizontal part 84B, a curved part 84C, and an inclined part 84D. The vertical part 84A, the horizontal part 84B, the curved part 84C, and the inclined part 84D link together in this recited order.

The vertical part 84A projects downward from the distal end of the curved joining part 83. The horizontal part 84B extends frontward from the lower end of the vertical part 84A so as to be parallel to the width direction. The curved part 84C projects upward from the frontward end of the horizontal part 84B, and curves in a U-shape to be convex frontward and open backward. The inclined part 84D projects backward from the upper end of the curved part 84C and is slightly inclined upward.

As shown in FIG. 11, the easily elastically deformable part 84 is formed to have two spring pieces whose both ends are joined. Specifically, the easily elastically deformable part 84 includes two spring pieces 90 that extend along the easily elastically deformable part 84, a fixed part-side joining part 91 that joins the two spring pieces 90 on the fixed part 80 side, and a contact part-side joining part 92 that joins the two spring pieces 90 on the contact part 85 side. The two spring pieces 90 are opposed to each other in the pitch direction and separated from each other in the pitch direction. The two spring pieces 90 extend parallel to each other. The fixed part-side joining part 91 is located in the vertical part 84A. The contact part-side joining part 92 is located in the inclined part 84D. Thus, the two spring pieces 90 are formed from the vertical part 84A to the inclined part 84D. In other words, a slit 93 that is surrounded by the two spring pieces 90, the fixed part-side joining part 91, and the contact part-side joining part 92 runs from the vertical part 84A to the inclined part 84D.

The two spring pieces 90 have the same cross-sectional area and cross-sectional shape. The cross-sectional areas and cross-sectional shapes of the two spring pieces 90 are equal. Each of the spring pieces 90 has a uniform cross-sectional area and cross-sectional shape at least in the zone of the horizontal part 84B and the curved part 84C.

The upper contact part 85 is a part that is designed to come into electrical contact with the corresponding signal pad 10 of the CPU board 2 shown in FIG. 2. As shown in FIG. 11, the contact part 85 is placed at the distal end of the inclined part 84D of the easily elastically deformable part 84, and it curves in a U-shape that is convex upward and opens downward.

As shown in FIG. 10, the displacement restriction part 86 includes two restriction pieces 86A that project oppositely from each other in the pitch direction from the distal end of the contact part 85.

As shown in FIG. 12, each contact 33 is formed symmetrically with respect to a bisecting line 33D (center line) that divides each contact 33 in half in the pitch direction.

FIG. 9 shows the state where each contact 33 is attached to each contact accommodation part 63. To attach each contact 33 to each contact accommodation part 63, each contact 33 is press-fit into the contact accommodation part main body 70 of each contact accommodation part 63 from below. Specifically, the two press-fit lances 80B of the fixed part 80 respectively bite into wall surfaces of the two pitch separating walls 74 that separate the contact accommodation part main body 70 in the width direction. The electrical contact spring piece 82 is thereby accommodated into the contact accommodation part main body 70, the position stabilization spring piece 81B of the soldering part 81 is accommodated into the solder connection checking hole 71, and the soldering part main body 81A of the soldering part 81 is accommodated into the notch 73.

In the above-described press-fitting process, the two displacement restriction parts 86 come into contact with the lower surfaces of the corresponding restriction walls 75, and thereby the easily elastically deformable part 84 is elastically deformed in such a way that the easily elastically deformable part 84 is compressed in the vertically direction. Thus, the electrical contact spring piece 82 is accommodated in the contact accommodation part main body 70 in the state where the easily elastically deformable part 84 is slightly elastically deformed. Further, in the above-described press-fitting process, since the width separating wall 72 is inserted between the fixed part 80 and the position stabilization spring piece 81B of the soldering part 81, the soldering part 81 is elastically deformed so that the position stabilization spring piece 81B is away from the fixed part 80 in the width direction. Then, in the state of being press-fit, the position stabilization spring piece 81B is pressed against the width separating wall 72 by the elastic restoring force of the soldering part 81. In other words, the width separating wall 72 is elastically interposed in the width direction between the fixed part 80 and the soldering part 81, and thereby the position of each contact 33 after the press-fitting is thereby stabilized.

When the soldering part main body 81A of the soldering part 81 is soldered to the corresponding signal pad 15 of the input-output board 4 shown in FIG. 1, a solder fillet, which is not shown, is formed between the soldering part 81 and the signal pad 15. In this embodiment, the presence of the solder fillet is checkable from above through the solder connection checking hole 71. This enables determining whether the soldering of each contact 33 is successfully made or not after mounting the connector 3 onto the input-output board 4.

Referring back to FIG. 1, when the CPU board 2 is fixed to the support board 5, the contact part 85 shown in FIG. 9 is pressed downward by the CPU board 2 and accommodated into the contact accommodation part main body 70. Specifically, when the CPU board 2 is fixed to the support board 5, the contact part 85 is elastically displaced downward by a predetermined amount. When the CPU board 2 is detached from the support board 5, the contact part 85 is elastically displaced upward by the elastic restoring force of the electrical contact spring piece 82, and then when the restriction pieces 86A reach the lower surface of the restriction wall 75, further displacement is restricted, and it returns to the state shown in FIG. 9.

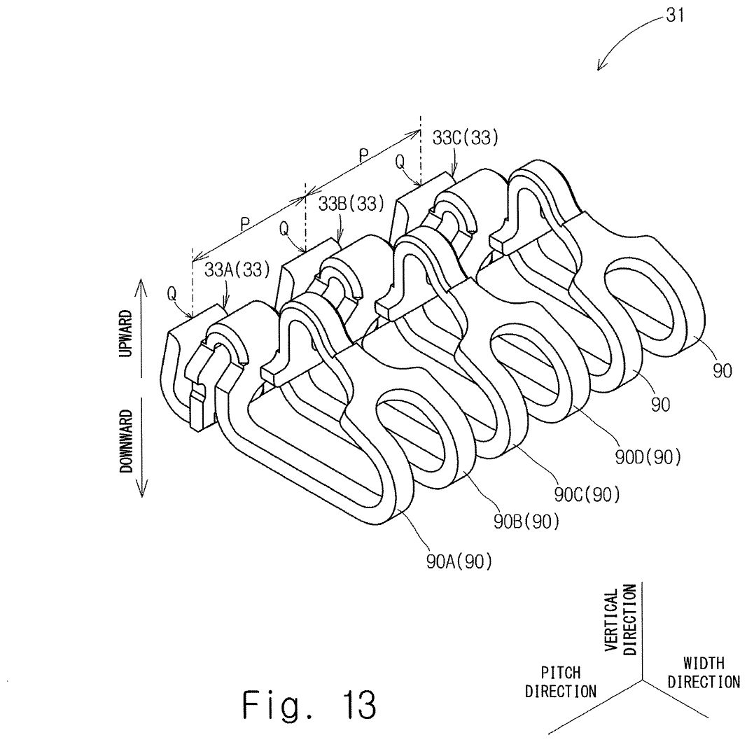

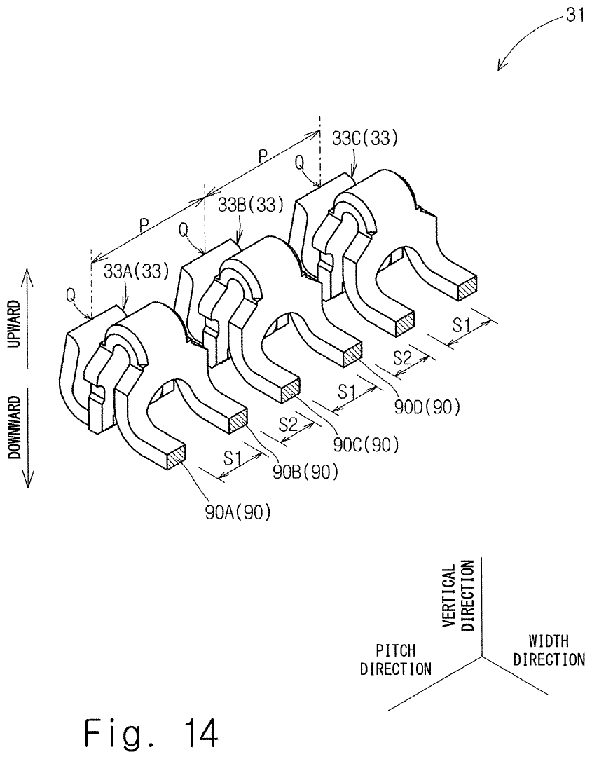

FIGS. 13 and 14 are perspective views of the contact row 31. FIGS. 13 and 14 show a pitch P of the contact row 31. FIG. 14 shows the pitch P, an inner spring gap S1, and an outer spring gap S2.

The pitch P of the contact row 31 is a distance in the pitch direction between reference points Q of the two adjacent contacts 33.

As shown in FIG. 14, the inner spring gap S1 is a gap in the pitch direction between the two spring pieces 90 of each contact 33.

The outer spring gap S2 is a gap in the pitch direction between, of the two contacts 33 adjacent in the pitch direction, the spring piece 90 closer to the other contact 33 out of the two spring pieces 90 of one contact 33 and the spring piece 90 closer to one contact 33 out of the two spring pieces 90 of the other contact 33.

Hereinafter, as shown in FIG. 14, the three contacts 33 that are contiguous in the pitch direction are referred to as a contact 33A, a contact 33B, and a contact 33C for the convenience of description. The contact 33A includes a spring piece 90A and a spring piece 90B. The spring piece 90B is closer to the contact 33B than the spring piece 90A is. The contact 33B includes a spring piece 90C and a spring piece 90D. The outer spring gap S2 is a gap in the pitch direction between the spring piece 90B and the spring piece 90C.

In this embodiment, the plurality of inner spring gaps S1 are equal, and the plurality of outer spring gaps S2 are also equal. Each inner spring gap S1 is designed to be greater than each outer spring gap S2. Note that, however, the plurality of inner spring gaps S1 may be different, and the plurality of outer spring gaps S2 may be different. Specifically, the outer spring gap S2 between the contact 33A and the contact 33B and the outer spring gap S2 between the contact 33B and the contact 33C may be different from each other.

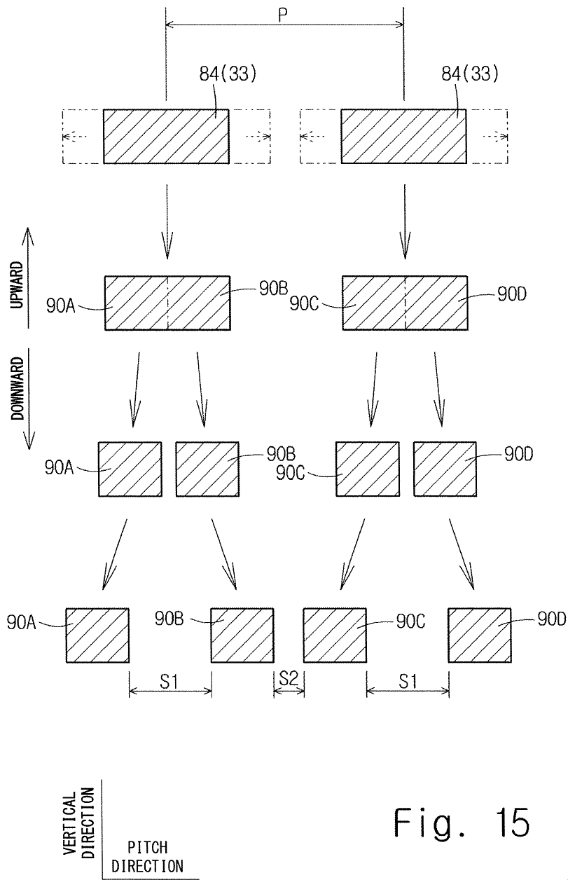

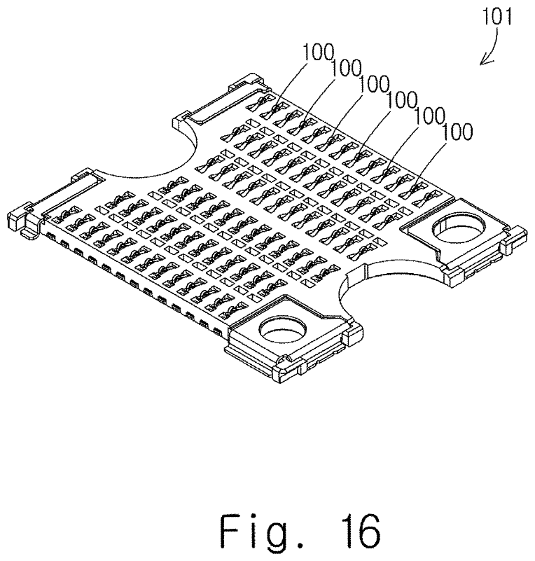

Referring now to FIGS. 15 and 16, an impedance adjustment method of each contact 33 is described hereinafter. FIG. 15 is a view showing only the cross-section in FIG. 14.

In the structure of Patent Literature 1 shown in FIG. 16, it is required to reduce the impedance of each contact 100 in order to achieve higher speed transmission. A typical technique to reduce the impedance of each contact 100 is narrowing the pitch of a plurality of contacts 100. This narrows the gap between two contacts 100 adjacent in the pitch direction, which reduces the impedance of each contact 100. In this case, however, it is necessary to simultaneously enhance the positioning accuracy of a board to be connected with the board-to-board connector 101 on the board-to-board connector 101, which is not practical.

Another technique to reduce the impedance of each contact 100 is widening each contact 100 without changing the pitch of the plurality of contacts 100. This also narrows the gap between two contacts 100 adjacent in the pitch direction, which reduces the impedance of each contact 100. In this case, however, each contact 100 is hardened and thereby likely to be settled, thus causing another problem. To be specific, the stiffness of a widened part of each contact 100 increases, and when elastically deforming each contact 100 by a predetermined amount by an external force acting on each contact, the widened part of each contact 100 becomes difficult to bend, and consequently only a non-widened part (for example, the curved joining part 83 and the contact part 85 shown in FIG. 10) would be forced to bend. As a result, a tensile stress exceeding the elastic limit occurs in the non-widened part, which can cause each contact 100 to become unable to elastically return to the state before application of the external force when removing the external force from each contact 100.

In view of the above, in this embodiment, the easily elastically deformable part 84 of each contact 33 is divided in half in the pitch direction as indicated by the chain double-dashed line in FIG. 15 rather than being expanded in the pitch direction, so that the two spring pieces 90 are separated away from each other in the pitch direction.

According to this technique, first, the pitch P of the contact rows 31 does not change. There is thus no need to enhance the positioning accuracy of the CPU board 2 and the input-output board 4 with respect to the connector 3.

Second, since the outer spring gap S2 is narrowed, the impedance of each contact 33 is reduced. Note that the size of the inner spring gap S1 of each contact 33 does not affect the impedance of each contact 33.

Third, since the cross-sectional second moment of the easily elastically deformable part 84 does not increase, the elasticity (bendability) of the easily elastically deformable part 84 does not change. The cross-sectional second moment of the easily elastically deformable part 84 is not affected by the sizes of the inner spring gap S1 and the outer spring gap S2. Thus, the curved joining part 83 and the contact part 85 are not forced to largely bend and be deformed, so that the elastic deformation of the electrical contact spring piece 82 is within the elastic limit in any part, and therefore the electrical contact spring piece 82 is able to elastically return with no problem and thus not likely to be settled.

Further, since no conductor exists in the inner spring gap S1 and the outer spring gap S2, and a stab for high-speed transmission is not formed, for example.

According to the above technique, the outer spring gap S2 is narrowed by separating the two spring pieces 90 of each contact 33 away from each other in the pitch direction while maintaining the pitch P of the contact rows 31 and the cross-sectional areas and cross-sectional shapes of the two spring pieces 90, which reduces the impedance of each contact 33 while maintaining the pitch P of the contact rows 31 and the elasticity of each contact 33.

An embodiment of the present invention is described above. The above-described embodiment has the following features.

As shown in FIG. 3, in the connector 3 where the plurality of contacts 33 having electrical conductivity are arranged in a row with a predetermined pitch P, the impedance of each contact 33 is adjusted as follows. As shown in FIG. 11, each contact 33 is designed in such a way that one contact part 85 is supported by the two spring pieces 90 extending apart from each other and parallel to each other in the pitch direction and whose both ends are joined. No conductor is designed to exist between the two spring pieces 90 of each contact 33. As shown in FIG. 13, no conductor is designed to exist between the two contacts 33 adjacent in the pitch direction. Then, as shown in FIG. 15, the outer spring gap S2 is narrowed by separating the two spring pieces 90 of each contact 33 away from each other in the pitch direction while maintaining the predetermined pitch P and the cross-sectional areas and cross-sectional shapes of the two spring pieces 90 of each contact 33, thereby reducing the impedance of each contact 33 while maintaining the predetermined pitch P and the elasticity of each contact 33. This method allows reducing the impedance of each contact 33 while maintaining the predetermined pitch P and the elasticity of each contact 33.

Further, as shown in FIG. 3, the connector 3 where the plurality of contacts 33 having electrical conductivity are arranged in a row with the predetermined pitch P is configured as follows. As shown in FIG. 11, in each contact 33, one contact part 85 is supported by the two spring pieces 90 extending apart from each other and parallel to each other in the pitch direction and whose both ends are joined. No conductor exists between the two spring pieces 90 of each contact 33. As shown in FIG. 13, no conductor exists between the two contacts 33 adjacent in the pitch direction. As shown in FIG. 15, the inner spring gap S1 in the pitch direction between the two spring pieces 90 of each contact 33 is greater than the outer spring gap S2. In this structure, the connector 3 where the impedance of each contact 33 is reduced while maintaining the predetermined pitch P and the elasticity of each contact 33 is achieved.

Further, as shown in FIG. 14, the cross-sectional areas and cross-sectional shapes of the two spring pieces 90 of the contact 33 are equal to each other.

Further, as shown in FIG. 11, the two spring pieces 90 are a cantilever beam at least partly bent in a U-shape.

Further, as shown in FIG. 12, each contact 33 is formed symmetrically with respect to the bisecting line 33D (center line).

Further, as shown in FIGS. 6 and 8, the connector 3 further includes the insulating housing 30 that holds the plurality of contacts 33. The housing 30 includes the plurality of contact accommodation parts 63 that accommodate the plurality of contacts 33, respectively, and the plurality of pitch separating walls 74 (partition walls) that separate the plurality of contact accommodation parts 63, respectively, in the pitch direction. As shown in FIGS. 6 to 13, the corresponding pitch separating wall 74 is disposed between, of the two contacts 33 adjacent in the pitch direction, the spring piece 90B closer to the other contact 33B out of the two spring pieces 90 of one contact 33A and the spring piece 90C closer to the one contact 33A out of the two spring pieces 90 of the other contact 33B. Since the insulating pitch separating wall 74 has a higher dielectric constant than air, this acts to reduce the impedance of each contact 33. Further, the insulating pitch separating wall 74 has an effect of preventing a short-circuit between the two contacts 33 adjacent in the pitch direction.

Further, as shown in FIG. 9, each contact 33 includes the soldering part 81 at an end on the opposite side of the contact part 85.

The above-described embodiment may be varied as follows, for example.

As shown in FIG. 3, the contact row 31 extends linearly along the pitch direction in the above-described embodiment. Alternatively, the contact row 31 may extend circularly when viewed from above.

Although, as shown in FIG. 1, the connector 3 is a board-to-board connector that connects the CPU board 2 and the input-output board 4 in the above-described embodiment, the present invention is not limited thereto. The connector 3 may be a cable-to-board connector or a cable-to-cable connector.

As shown in FIG. 11, the electrical contact spring piece 82 includes the two spring pieces 90 opposed to each other in the pitch direction in the above-described embodiment. Alternatively, the electrical contact spring piece 82 may include three or more spring pieces 90 arranged in the pitch direction.

Referring to FIG. 15, the two spring pieces 90 are separated away from each other in order to adjust the impedance of each contact 33. In the actual process of manufacturing the two spring pieces 90, the two spring pieces 90 may be formed by making a cut in the easily elastically deformable part 84 during punching and then deformed to be separated away from each other, or the two spring pieces 90 separated away from each other in the pitch direction may be formed during punching.

This application is based upon and claims the benefit of priority from Japanese patent application No. 2021-165969 filed on Oct. 8, 2021, the disclosure of which is incorporated herein in its entirety by reference.

### REFERENCE SIGNS LIST

1 INFORMATION PROCESSING DEVICE
2 CPU BOARD
2A CONNECTOR OPPOSED SURFACE
3 CONNECTOR (CONNECTOR FOR HIGH-SPEED TRANSMISSION)
4 INPUT-OUTPUT BOARD
4A CONNECTOR OPPOSED SURFACE
5 SUPPORT BOARD
6 SIGNAL PAD ROW
8 BOLT FASTENING HOLE
8A FIRST BOLT FASTENING HOLE
8B SECOND BOLT FASTENING HOLE
8C THIRD BOLT FASTENING HOLE
10 SIGNAL PAD
11 SIGNAL PAD ROW
12 HOLD-DOWN PAD
13 BOLT FASTENING HOLE
13A FIRST BOLT FASTENING HOLE
13B SECOND BOLT FASTENING HOLE
13C THIRD BOLT FASTENING HOLE
15 SIGNAL PAD
20 BOARD MAIN BODY
21 NUT
21A FIRST NUT
21B SECOND NUT
21C THIRD NUT
30 HOUSING
30A CPU BOARD OPPOSED SURFACE
30B INPUT/OUTPUT BOARD OPPOSED SURFACE
31 CONTACT ROW
32 HOLD-DOWN
33 CONTACT
33A CONTACT
33B CONTACT
33C CONTACT
33D BISECTING LINE (CENTER LINE)
40A FIRST BOLT
40B SECOND BOLT
40C THIRD BOLT
62 CONTACT ACCOMMODATION ROW
63 CONTACT ACCOMMODATION PART
70 CONTACT ACCOMMODATION PART MAIN BODY
71 SOLDER CONNECTION CHECKING HOLE
72 WIDTH SEPARATING WALL
73 NOTCH
74 PITCH SEPARATING WALL (PARTITION WALL)
75 RESTRICTION WALL
80 FIXED PART
80A FIXED PART MAIN BODY
80B PRESS-FIT LANCE
81 SOLDERING PART
81A SOLDERING PART MAIN BODY
81B POSITION STABILIZATION SPRING PIECE
82 ELECTRICAL CONTACT SPRING PIECE
83 CURVED JOINING PART
84 EASILY ELASTICALLY DEFORMABLE PART
84A VERTICAL PART
84B HORIZONTAL PART
84C CURVED PART
84D INCLINED PART
85 CONTACT PART
86 DISPLACEMENT RESTRICTION PART
86A RESTRICTION PIECE
90 SPRING PIECE
90A SPRING PIECE
90B SPRING PIECE
90C SPRING PIECE
90D SPRING PIECE
91 FIXED PART-SIDE JOINING PART
92 CONTACT PART-SIDE JOINING PART
93 SLIT
P PITCH
Q REFERENCE POINT
S1 INNER SPRING GAP (GAP)
S2 OUTER SPRING GAP (GAP)

1. An impedance adjustment method for adjusting impedance of each contact in a connector where a plurality of contacts having electrical conductivity are arranged in a row with a predetermined pitch, wherein
each contact is designed in such a way that one contact part is supported by two spring pieces extending apart from each other in a pitch direction and parallel to each other and whose both ends are joined,
no conductor is designed to exist between the two spring pieces of each contact,
no conductor is designed to exist between two contacts adjacent in the pitch direction, and
a gap in the pitch direction between, of two contacts adjacent in the pitch direction, a spring piece closer to another contact out of the two spring pieces of one contact and a spring piece closer to the one contact out of the two spring pieces of the another contact is narrowed by separating the two spring pieces of each contact away from each other in the pitch direction while maintaining the predetermined pitch and cross-sectional areas and cross-sectional shapes of the two spring pieces of each contact, thereby reducing impedance of each contact while maintaining the predetermined pitch and elasticity of each contact.

2. A connector for high-speed transmission where a plurality of contacts having electrical conductivity are arranged in a row with a predetermined pitch, wherein
in each contact, one contact part is supported by two spring pieces extending apart from each other in a pitch direction and parallel to each other and whose both ends are joined,
no conductor exists between the two spring pieces of each contact,
no conductor exists between two contacts adjacent in the pitch direction, and
a gap in the pitch direction between the two spring pieces of each contact is greater than a gap in the pitch direction between, of two contacts adjacent in the pitch direction, a spring piece closer to another contact out of the two spring pieces of one contact and a spring piece closer to the one contact out of the two spring pieces of the another contact.

3. The connector for high-speed transmission according to claim 2, wherein cross-sectional areas and cross-sectional shapes of the two spring pieces are equal to each other.

4. The connector for high-speed transmission according to claim 2, wherein the two spring pieces are a cantilever beam at least partly bent in a U-shape.

5. The connector for high-speed transmission according to claim 2, wherein each contact is formed symmetrically with respect to a center line.

6. The connector for high-speed transmission according to claim 2, further comprising:
an insulating housing that holds the plurality of contacts, wherein
the housing includes a plurality of contact accommodation parts that accommodate the plurality of contacts, respectively, and a plurality of partition walls that separate the plurality of contact accommodation parts, respectively, in the pitch direction, and
a corresponding partition wall is disposed between, of two contacts adjacent in the pitch direction, a spring piece closer to another contact out of the two spring pieces of one contact and a spring piece closer to the one contact out of the two spring pieces of the another contact.

7. The connector for high-speed transmission according to claim 2, wherein each contact includes a soldering part at an end on an opposite side of the contact part.
